(19) United States
(12) Patent Application Publication
(10) Pub. No.: US 2011/0318705 A1
(43) Pub. Date: Dec. 29, 2011

(54) Hydro clean auto floss

(76) Inventors: John P. Sullivan, Frankfort, IL (US); Michael D. LaMorte, Frankfort, IL (US)

(21) Appl. No.: 13/134,882

(22) Filed: Jun. 20, 2011

Related U.S. Application Data
(60) Provisional application No. 61/397,962, filed on Jun. 18, 2010.

(51) Int. Cl. A61C 17/032

(52) U.S. Cl. 433/80

(57) ABSTRACT

The Hydro Clean Auto Floss provides a molded mouth-guard type mouthpiece configured in a U shape to conform to the contours of a set of human teeth, having a trough to receive the teeth, further comprising an irrigation water flow component at the front thereof consisting of an attachable tubing apparatus, allowing users to floss all of the teeth by means of pressurized water, at once, whether at home or on the go. A series of small circular openings are positioned along the perimeter of the mouthpiece, serving as the egress for water. At the front of the mouthpiece is positioned the attachment point for the irrigation water flow component. The irrigation water flow component comprises one central inlet nozzle, and two outlet nozzles, positioned on each side of the inlet nozzle. All of these nozzles are designed to receive tubing by means of a force fit. At the opposite end of the inlet hose is a spout adapter that is configured to accommodate most sink faucets.

### CLAIM OF PRIORITY

This patent application claims priority under 35 USC 119 (e) (1) from U.S. Provisional Patent Application Ser. No. 61/397,962 filed Jun. 18, 2010, of common inventorship herewith entitled, “Hydro Clean Auto Floss.”

### FIELD OF THE INVENTION

The present invention pertains to the field of dental hygiene devices, and more specifically to the field of irrigating dental cleaning devices.

### BACKGROUND OF THE INVENTION

The prior art has put forth several designs for irrigating dental cleaning devices. Among these are:

U.S. Pat. No. 3,731,675 to James J. Kelly describes an apparatus for cleaning and polishing teeth and particularly the interproximal surfaces and gingival crevices thereof wherein a mouthpiece adapted to fit over at least a portion of the dentition and sealable engage the gums includes a plurality of interiorly disposed spaced inlet and exhaust ports in communication with a source of fluid or other cleansing material and an evacuation pump.

U.S. Pat. No. 6,152,733 to Kenneth J. Hegemann, et al describes an automated hands-free personalized cleansing device for oral hygiene in which a robotic cleansing head is mounted for reciprocatable movement on a mounting base and is powered and controlled by a computer module.

U.S. Pat. No. 6,893,259 to Igor Reizenson describes an oral hygiene device including, in combination, a system for relatively effortlessly and effectively cleansing dental, inter-dental, gingival and deep-gum surfaces and crevices, and a convenient teeth bleaching system which may be utilized in conjunction with, or in lieu of, conventional brushing and/or flossing practices.

None of these prior art references describe the present invention.

### SUMMARY OF THE INVENTION

It is an object of the present invention to provide an irrigating dental cleaning device.

### BRIEF DESCRIPTION OF THE DRAWINGS

FIG. 1 is an elevational angled perspective front view of the device of the present invention having the irrigation water flow component attached.

FIG. 2 is an elevational angled perspective rear view of the mouth piece portion of the device of the present invention.

FIG. 3 is a side view of the device of the present invention having the irrigation water flow component attached.

FIG. 4 is a top view of the device of the present invention having the irrigation water flow component attached, showing water inlet center nozzle and water outlet nozzles.

FIG. 5 is a side view of the internal components of device of the present invention having the irrigation water flow component attached.

FIG. 6 is a top view of the internal components of device of the present invention having the irrigation water flow component attached.

FIG. 7 is a front view of the device of the present invention.

FIG. 8 is a back view of the device of the present invention.

FIG. 9 is an elevational angled perspective front view of the mouth piece portion of the device of the present invention.

FIG. 10 is a cutaway view of the mouthpiece of the present invention showing the nozzles for in flow of water flow and the outlet channel for the out flow of water.

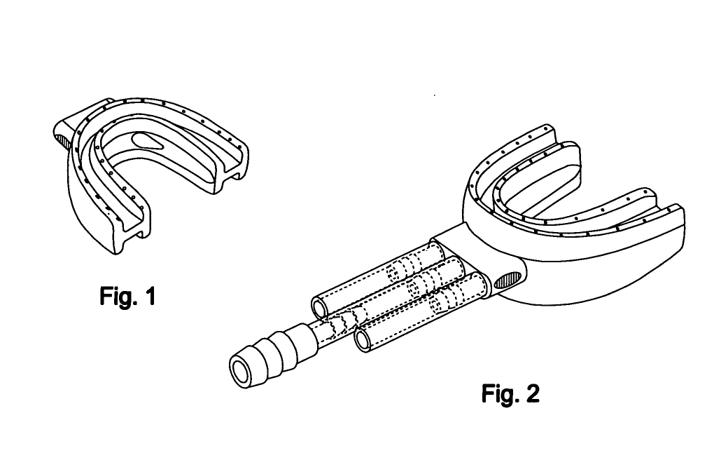

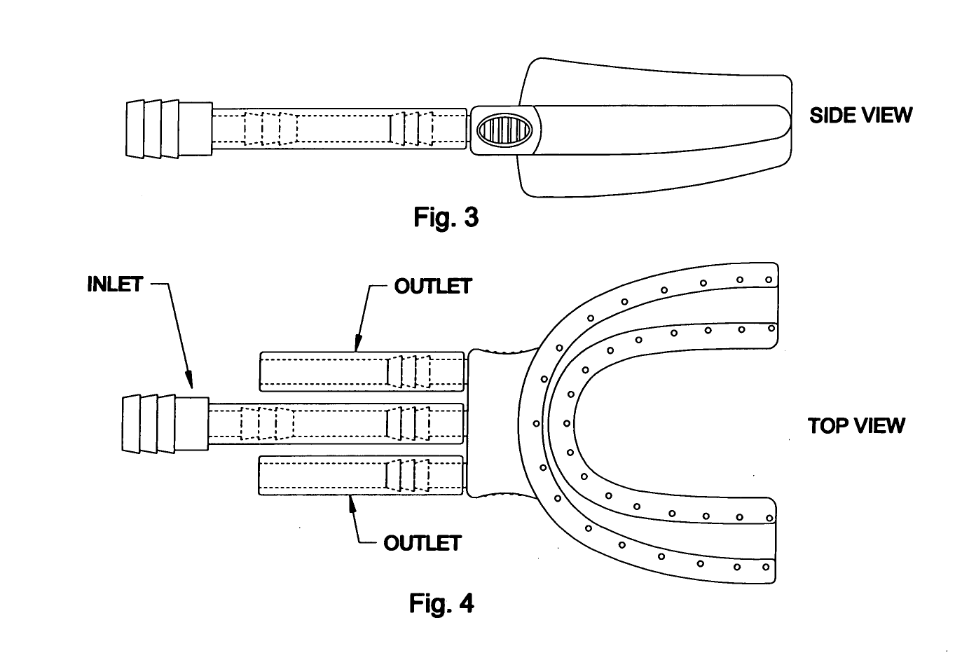

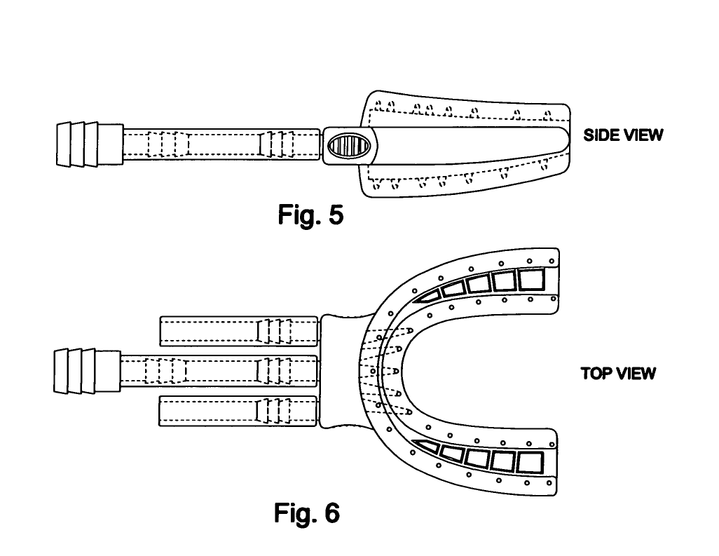

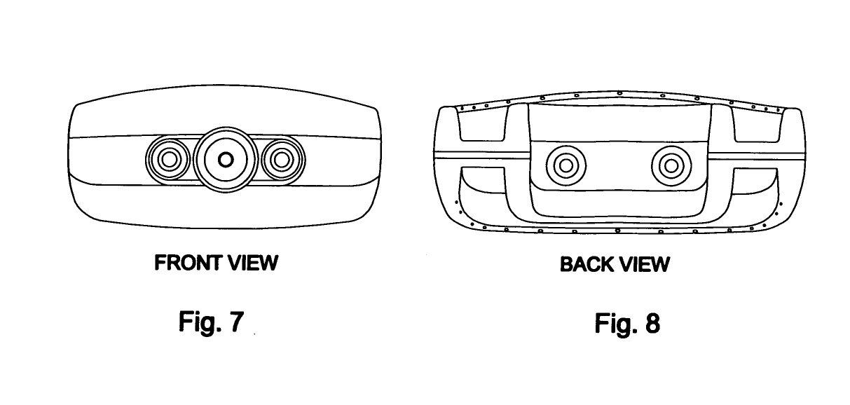

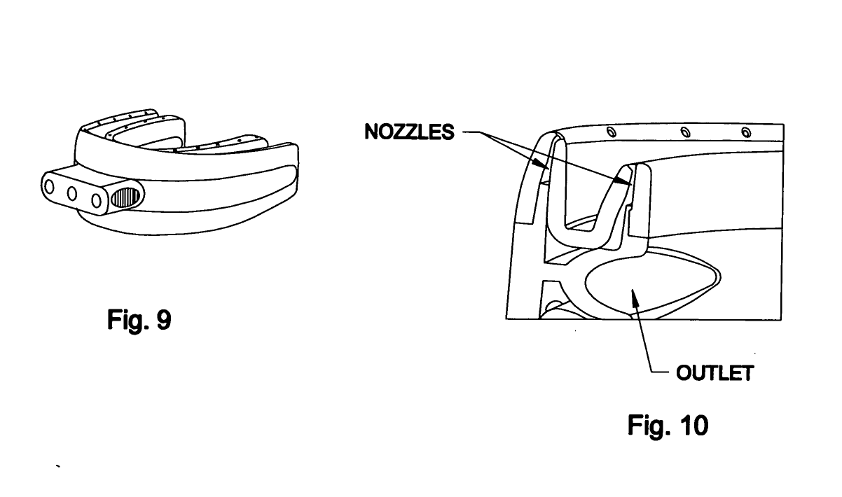

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art.

Brushing one's teeth is one of the most important parts of healthy hygiene. In addition to freshening the breath and strengthening the teeth, proper brushing also kills the germs and bacteria that can grow inside the mouth. Recently, the Office of the Surgeon General released its first ever report on oral health and the results were surprising. According to the report, the most common chronic childhood disease by far in this country is tooth decay. In fact, children lose a staggering 512 million school hours a year due to dental related illness. Adults also suffer from various forms of dental disease and these complications can lead to painful oral surgeries and costly trips to the dentist. A booming industry, the national health expenditures for dental services exceeded sixty billion dollars in the year 2007. While the Office of the Surgeon General reports that there have been vast improvements in the past fifty years regarding oral health issues, much can still be done in this area. Health professionals maintain that through education and a concerted effort, the number of adults and children suffering from dental disease can be significantly reduced.

To have a healthy smile, the American Dental Association recommends that teeth should be brushed at least twice daily, preferably after meals. In addition to brushing, daily flossing has been the prescription for healthy teeth and gums offered by dental hygienists for over 80 years. However, according to an ADA survey, only 5% of adults floss daily. The American Academy of Periodontology lists the many excuses offered for the lack of flossing, from bleeding gums to dexterity difficulties to the time-consuming nature of the practice. Seen by many as more of a daunting chore than a beneficial dental regimen, the idea of wrestling with an unwieldy length of string to clean between the teeth is, unfortunately, easily discarded in today's fast-paced world.

The present invention, hereinafter referred as the Hydro Clean Auto Floss is a molded mouth-guard type mouthpiece configured in a U shape to conform to the contours of a set of human teeth, having a trough to receive the teeth, further comprising an irrigation water flow component at the front thereof consisting of an attachable tubing apparatus, allowing users to floss all of the teeth by means of pressurized water, at once, whether at home or on the go. The mouthpiece is molded into a one size fits all model, facilitating a comfortable fit when placed into the mouth. A series of small circular openings are positioned along the perimeter of the mouthpiece, serving as the egress for water. The mouthpiece of the Hydro Clean Auto Floss also features a force fit opening, which serves as the attachment point for the irrigation water flow component. The irrigation water flow component comprises one central inlet nozzle, and two outlet nozzles, positioned on each side of the inlet nozzle. All of these nozzles are designed to receive tubing by means of a force fit. The lengths of hose tubing is intended to be provided with the device. At the opposite end of the inlet hose is a spout adapter that is configured to accommodate most sink faucets.

In an alternative embodiment, The Hydro Clean Auto Floss has a small compartment with a cap that is attached to the input line and is filled with mouthwash and squeezed into the input line. The Hydro Clean Auto Floss is packaged within a durable plastic casing to protect the unit from airborne germs and bacteria when not in use. Other embodiments are produced in a variety of attractive and eye catching colors, as well as various sizes to appeal to and accommodate both adults and children.

Use of the Hydro Clean Auto Floss is very simple and straightforward. First, the user places an encased unit on the person before heading out on an intended activity. By way of example, a business executive slips a unit into his interior coat pocket on his way to work. Similarly, a mother embarking on a shopping expedition simply inserts a Hydro Clean Auto Floss system into her purse. Following a meal, the user removes the unit from its packaging, and connects the hose to the brush and to the nearest sink faucet. After inserting the mouthpiece along the teeth, the water from the sink is channeled through the tube and into the mouth, and the pressure is able to remove food particles from between the teeth.

There are several significant benefits and advantages associated with this clever product invention. Foremost, the Hydro Clean Auto Floss offers consumers a more appealing approach to completing the flossing chore. A specially designed mouthpiece configured with a water hose connector, this unique product allows users to floss in record time. In this manner, users do not have to uncomfortably strangle the fingers to more effectively accomplish the flossing task. In addition, the models offered by this versatile product line appeal to virtually any user, further encouraging both young and old to add flossing to their dental care regimen. Consumers appreciate that this product not only allows them to look out for their dental health, but is also an effective step that will ensure overall health and well-being. Not just restricted to household use, domestic and foreign travelers find the Hydro Clean Auto Floss especially convenient. Compact and lightweight, a package of this handy product is easily packed into any shaving kit, travel bag, or carry-on. Hotel guests also enjoy the convenience of the Hydro Clean Auto Floss, as it is made available in hotel gift shops and at lobby desks. Offered along with forgotten toothpaste and brush, this product provides hotel guests with a quick and sanitary oral solution while they are away from home.

The Hydro Clean Auto Floss is an innovative product invention which provides a helpful assist in increasing the number of people who floss on a daily basis. Versatile and convenient, this product offers a user-friendly approach to healthy oral hygiene and can be used by adults and children alike.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An irrigating dental cleaning device, comprising a molded mouth-guard type mouthpiece configured in a U shape to conform to the contours of a set of human teeth, having a trough to receive the teeth, further comprising an irrigation water flow component at the front thereof consisting of an attachable tubing apparatus, allowing users to floss all of the teeth simultaneously by means of pressurized water.

2. The device of claim 1 wherein the mouthpiece comprises a series of circular openings positioned along the perimeter of the mouthpiece, said openings serving as the egress for water, the device further comprising a force fit opening, which opening serves as the attachment point for the irrigation water flow component, wherein the irrigation water flow component comprises one central inlet nozzle, and two outlet nozzles, positioned on each side of the inlet nozzle, wherein all of these nozzles are designed to receive tubing by means of a force fit.

3. The device of claim 2 wherein the opposite end of the tubing attached to the inlet nozzle is a spout adapter that is configured to accommodate most sink faucets.

4. The device of claim 3 further comprising a small compartment with a cap that is attached to the inlet tubing, wherein the compartment is filled with mouthwash, and the mouthwash can be squeezed into the input line.

5. The device of claim 2, wherein the device is packaged within a durable plastic casing to protect the unit from airborne germs and bacteria when not in use.
